(19) United States
(12) Patent Application Publication
(10) Pub. No.: US 2025/0337784 A1
(43) Pub. Date: Oct. 30, 2025

(54) COMPLIANCE POLICY MANAGEMENT

(71) Applicant: Dell Products L.P., Round Rock, TX (US)

(72) Inventors: BRADLEY K. GOODMAN, Nashua, NH (US); MAXIM BALIN, Gan-Yavne (IL); JOSEPH CAISSE, Burlington, MA (US)

(21) Appl. No.: 18/645,953

(22) Filed: Apr. 25, 2024

(51) Int. Cl. H04L 9/40

(52) U.S. Cl. CPC H04L 63/20; H04L 63/0823

(57) ABSTRACT

Methods and systems for managing endpoint devices are disclosed. The endpoint devices may be managed by identifying compliance states for the endpoint devices. The compliance state may be identified based on compliance policies that are enrolled for use with respect to a deployment or other computing system. The compliance states may be used to identify how to perform various types of processes such as onboarding, workload assignment, and/or other types of processes in which the endpoint devices may participate.

### FIELD

Embodiments disclosed herein relate generally to device management. More particularly, embodiments disclosed herein relate to systems and methods to devices based on compliance states.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-1K show diagrams illustrating aspects of operation of the system of FIG. 1A in accordance with an embodiment.

FIGS. 2A-2B show interaction diagrams in accordance with an embodiment.

FIG. 2C shows a data flow diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a distributed system. To manage operation, compliance policies may be used to judge whether endpoint devices exhibit undesirable levels of risk to the distributed system.

The compliance policies may be established or adopted by entities that operate the distributed systems. Each of the compliance policies may specify, for example, metrics and requirements usable to judge the endpoint devices. Scoring systems may also be used to facilitate the judgements.

The operation of the distributed system and endpoint device may be modified based on whether each endpoint devices is judged to be compliance with the compliance policies. If judged to not be compliant, an endpoint device may be excluded from certain processes (e.g., onboarding, workload assignment, etc.).

By doing so, embodiments disclosed herein may reduce the likelihood that endpoint devices of distributed systems are used as attack vectors for the distributed system, and workloads performed thereof. Accordingly, embodiments disclosed herein may address, among others, the technical problem of security in a distributed system. The disclosed embodiments may do so by providing a framework for judging endpoint devices with respect to risks tailored to an operator's preference.

In an embodiment, a method for managing endpoint devices is provided. The method may include identifying an occurrence of a validation event for an endpoint device of the endpoint devices; based on the occurrence of the validation event: identifying a compliance policy which governs the endpoint device; obtaining, from the endpoint device and based at least on the compliance policy, compliance data; identifying, based on at least the compliance policy and the compliance data, a compliance state for the endpoint device; and managing operation of the endpoint device based on the compliance state.

The compliance policy may be specified by an operator a deployment which the endpoint device is attempting to join.

The validation event may be an attempted onboarding of the endpoint device to the deployment.

Managing operation of the endpoint device may include in a first instance of the identifying where the compliance state is non-compliant: preventing the onboarding of the endpoint device to complete prior to remediation of the compliance state; and in a second instance of the identifying where the compliance state is compliant: allowing the onboarding of the endpoint device to be completed without the remediation of the compliance state.

The method may also include providing computer implemented services using the endpoint device after onboarding to the deployment is completed.

The compliance policy may specify metrics which must be met for the compliance state of the endpoint device to be identified as compliant.

The metrics may include at least one metric selected from a list of metrics consisting of: possession of a first certificate indicating that the endpoint device was manufactured by a predetermined entity and signed by the predetermined entity; possession of a second certificate indicating that the endpoint device was manufactured by a predetermined entity and signed by an intermediate entity which the predetermined entity has delegated authority over the endpoint device; possession of a third certificate indicating that the endpoint device is a particular type of device; and possession of a fourth certificate indicating that the endpoint device comprises a particular type of hardware.

At least one of the first certificate, the second certificate, the third certificate, and the fourth certificate may be part of an onboarding voucher that delegates authority of the endpoint device to an operator of the endpoint device.

The compliance policy may further specify characteristics of the endpoint device which must be met for the compliance state of the endpoint device to be identified as compliant.

The characteristics may include at least one characteristic selected from a list of characteristics consisting of: a type of hardware component in an inventory of the endpoint device; a type of firmware hosted by the endpoint device; a type of boot loader hosted by the endpoint device; a type of operating system hosted by the endpoint device; and a security architecture implemented by the endpoint device.

The method may also include obtaining a scoring system; and obtaining a quantification based, at least in part, on the compliance policy. The compliance state may be identified by comparing the quantification to a criteria specified by the scoring system.

The validation event may be an assignment of a workload.

Managing the operation of the endpoint device may include in a first instance of the identifying where the compliance state is non-compliant: rejecting the endpoint device as a candidate for the workload; and in a second instance of the identifying where the compliance state is compliant: accepting the endpoint device as the candidate for the workload. The validation event may be an audit for the endpoint device.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

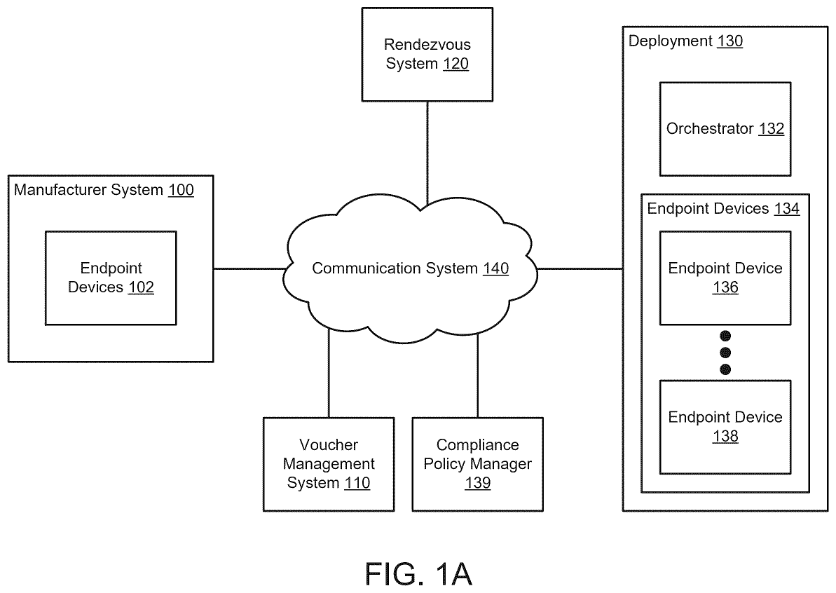

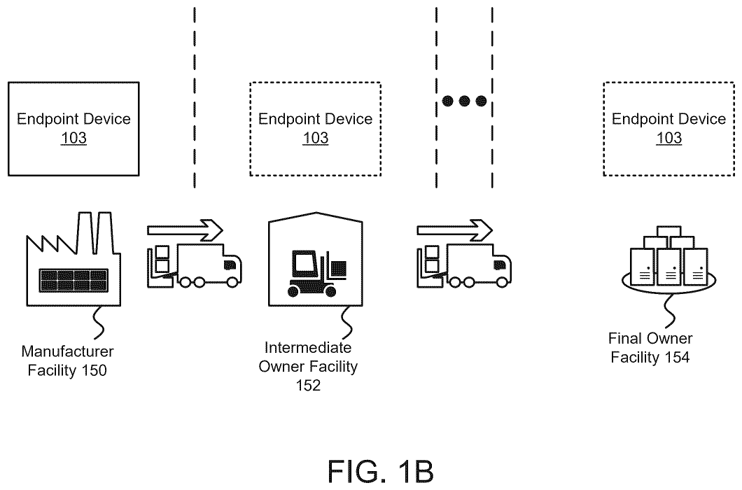

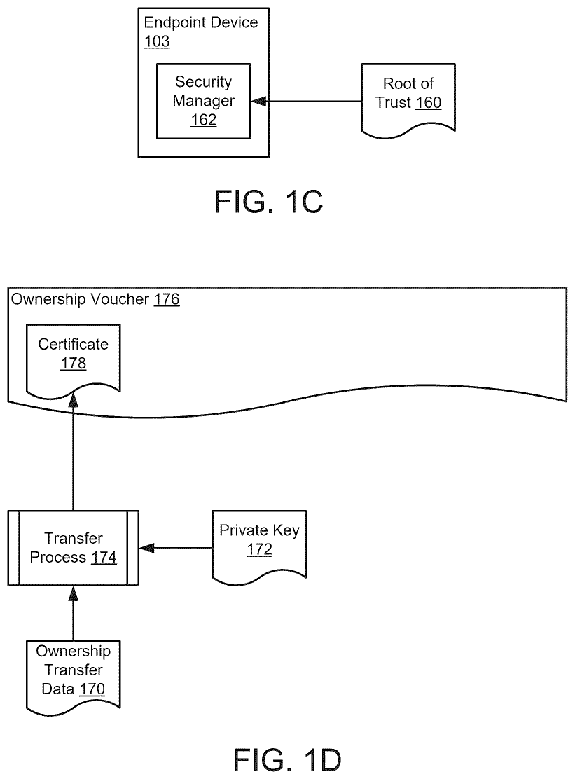

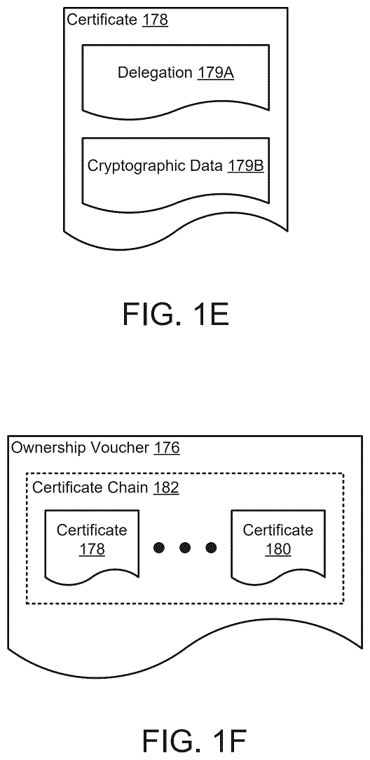

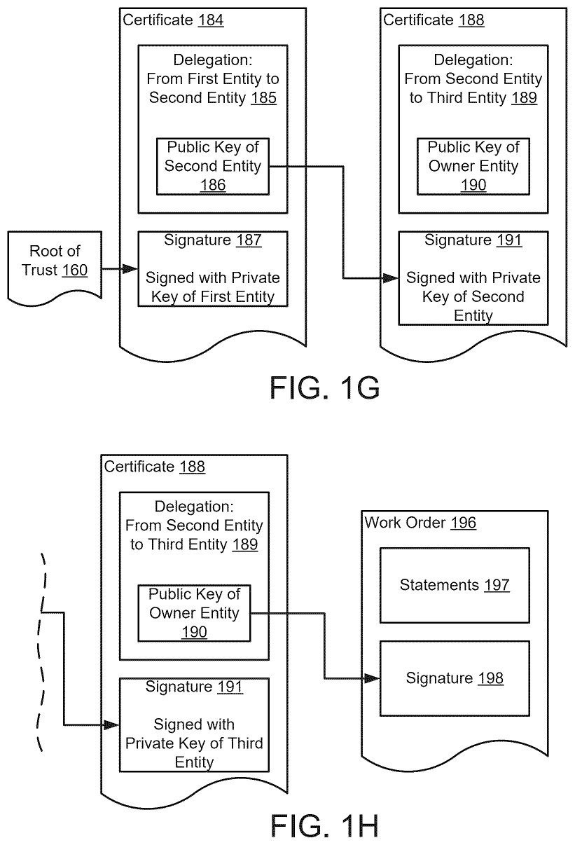

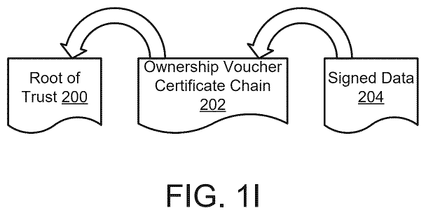

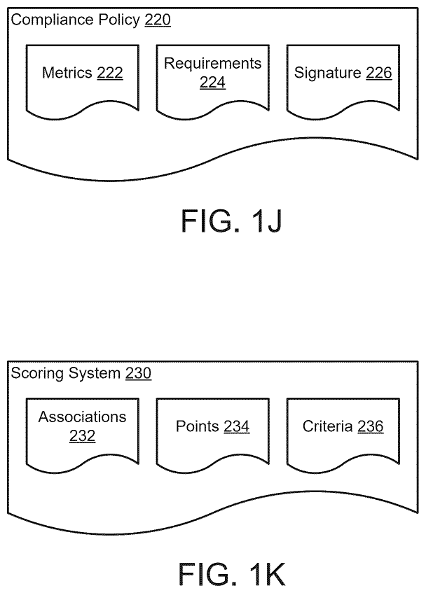

Turning to FIG. 1A, a block diagram illustrating a system in accordance with an embodiment is shown. The system shown in FIG. 1A may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, any number of endpoint devices may be deployed to a deployment. The endpoint devices may cooperatively provide the computer implemented services.

To manage the endpoint devices to provide the computer implemented services, authority over the endpoint devices may need to be established. In other words, the endpoint devices must be able to ascertain that they are under the authority of a particular entity. Based on this authority, the entity may, for example, issue work order and/or other types of instructions to manage the operation of the endpoint devices to provide desired computer implemented services.

To facilitate ascertaining of the authority over them, the endpoint devices may utilize secrets. The secrets may allow the endpoint devices to cryptographically verify delegations of authority over the endpoint devices from a root of trust (e.g., a trusted key of a manufacturer) to another entity (e.g., an owner).

Overtime the resources requirements for providing computer implemented services may change and/or endpoint devices may need to be replaced. For example, additional services may be desired to be provided, different types of services may be desired to be provided, etc. In another example, an endpoint device that contributed to the computer implemented services may cease to operate thereby reducing the quantity of resources available to provide the computer implemented services. To satisfy the resource requirements based on these changes to an exist systems, additional endpoint devices may be onboarded and thereby contribute to the resources available to provide the computer implemented services.

However, onboarding an endpoint device may present risk to the operation of the deployment. For example, if an endpoint device is onboarded that is or may be compromised in the future, the operation of the comprised endpoint device may serve as an attack vector for other endpoint devices of the deployment. Likewise, if an endpoint device in a deployment is compromised, assignment of a workload to the endpoint device may result in the workload being compromised.

In general, embodiments disclosed herein may provide methods, systems, and/or devices for managing endpoint devices to reduce the likelihood of the endpoint devices compromising services provided by and/or operation of a deployment. To improve the security of such deployments, embodiments disclosed herein may provide a framework for analyzing endpoint devices with respect to their individual risk of compromise. If the level of risk meets certain criteria, the endpoint devices may, for example, be excluded from onboarding the deployments, from performing certain workloads, and/or may otherwise be managed in a manner that reduce the likelihood of the operation of endpoint devices compromising services provided by a deployment.

To identify the level of risk presented by each endpoint device, a flexible system of policies may be utilized. Compliance policies may be used to ascertain whether a particular endpoint device meets a minimum standard (e.g., a baseline) established by or adopted by an operator of a deployment.

To further granularly ascertain levels of risk presented by endpoint devices, scoring systems to quantify the level of risk may be used in conjunction with the compliance policies. For example, the scoring systems may be established by or adopted by an operator of a deployment. The scoring system may ascribe quantifications to different characteristics of endpoint devices and/or other metrics specified by the compliance policies. The resulting quantifications may be compared to various criteria to qualify or disqualify endpoint devices for various types of activity (e.g., onboarding, performance of workloads, etc.).

By doing so, embodiments disclosed herein may enable risk evaluations for endpoint devices to be customized based on operator end uses, geographic location, and/or other factors. The evaluations may be performed using cryptographically verifiable data structures thereby reducing risk of the evaluation framework itself being compromised. Thus, endpoint devices and deployments in accordance with embodiments disclosed herein may be less likely to be compromised thereby improving the quality of the computer implemented services provided through these systems.

To provide the above noted functionality, the system of FIG. 1A may include manufacturer system 100, voucher management system 110, rendezvous system 120, deployment 130, compliance policy manager 139, and communication system 140. Each of these components is discussed below.

Manufacturer system 100 may be a system used by a manufacturer of endpoint devices 102. Manufacturer system 100 may include, for example, factories, assembly plants, distribution facilities, and/or other types of facilities for creating endpoint devices 102. Endpoint devices 102 may be data processing systems which may be usable to provide various computer implemented services.

When manufactured, manufacturer system 100 may put endpoint devices 102 in condition for subsequent onboarding to various deployments (e.g., 130) and/or other environments (e.g., data centers, edge systems, etc.) in which endpoint devices may be positioned to provide desired computer implemented services.

To place endpoint device 102 in condition for subsequent onboarding, manufacturer system 100 may (i) establish a root of trust for each endpoint device, (ii) record various information regarding the endpoint devices (e.g., hardware/software loadout, identifiers of various components positioned therein, etc.), and (iii) install various pieces of software, establish various configuration settings, update various hardware components, and/or perform other actions so that only entities to which authority over the endpoint devices has been delegated from the root of trust are able to control and/or otherwise use the endpoint device. Refer to FIG. 1C for additional details regarding establishing a root of trust for the endpoint device.

Once constructed, endpoint devices 102 may be sold directly to end users and/or placed into the stream of commerce (e.g., sold to resellers, etc.) and through which endpoint devices 102 eventually reach end users. The intermediate owners may make modifications to the hardware and/or software of the endpoint devices. Refer to FIG. 1B for additional details regarding how endpoint devices may reach end users (e.g., individuals, organizations, etc.).

As ownership over the endpoint devices changes, information regarding the changes in ownership and/or authority may be recorded in an ownership voucher. The ownership voucher may allow an end user to establish authority over the endpoint device such that the endpoint device will be usable by the end user.

Voucher management system 110 may document and manage information regarding changes in ownership and authority over endpoint devices 102. To do so, voucher management system 110 may generate ownership vouchers. An ownership voucher may be a cryptographically verifiable data structure usable to establish which entities have authority over endpoint devices 102.

For example, an ownership voucher may include certificate chains that documents the changes in ownership and authority over endpoint devices 102. Each certificate may be signed using various keys. The keys used to sign (e.g., private keys) and keys included in (e.g., public keys) in ownership vouchers may enable endpoint devices to ascertain whether to trust various data structures, such as work orders which may be signed. Refer to FIGS. 1D-1I for additional information regarding ownership vouchers.

When one of endpoint devices 102 is obtained by an end user, the end user may add the endpoint devices to a collection such as deployment 130. When so added, an orchestrator (e.g., 132) or other entity may utilize a corresponding ownership voucher from voucher management system 110 to establish authority over the endpoint device. In this manner, any number of endpoint devices (e.g., 134) may be onboarded and brought under the control of a control plane which may include any number of orchestrators (e.g., 132). Different endpoint devices (e.g., 136, 138) may be onboarded at different points in time and/or for different purposes.

However, as noted above, adding an endpoint devices to endpoint devices (e.g., 134) of a deployment may present risk. Prior to allowing the endpoint devices to onboard, prior to assigning workloads, during auditing, and/or during other processes, orchestrator 132 may validate that an endpoint device meets standards as specified or adopted by an operator of a deployment (e.g., 130). Refer to FGIs. 2A-2C for additional details regarding verification of an endpoint device.

When one of endpoint devices 102 initially powers on after manufacturing and prior to onboarding, the endpoint device may reach out to rendezvous system 120. Rendezvous system 120 may be a system that directs endpoint devices to entities such as orchestrator 132 that will onboard the endpoint devices.

To do so, the entities such as orchestrator 132 may provide rendezvous system 120 with information usable to authenticate that orchestrator 132 will manage the endpoint devices. For example, orchestrator 132 may provide information from ownership and/or other sources to rendezvous system 120. Once verified, rendezvous system 120 may redirect endpoint devices to the corresponding entities when the endpoint devices reach out to rendezvous system 120 after being powered on.

Once onboarded, endpoint devices 134 may perform various operations to complete onboarding. The operations may include any number and type of operation (e.g., configuration operations, security operations, software installation operations, account establishment operations, etc.), and the operations may be directed by orchestrator 132. Once onboarded, the endpoint devices may begin to contribute to computer implemented services provided by deployment 130.

When providing their functionality, any of manufacturer system 100, endpoint devices 102, voucher management system 110, rendezvous system 120, deployment 130, orchestrator 132, endpoint devices 134, and/or compliance policy manager 139 may perform all, or a portion, of the processes, interactions, and methods illustrated in FIGS. 1B-3.

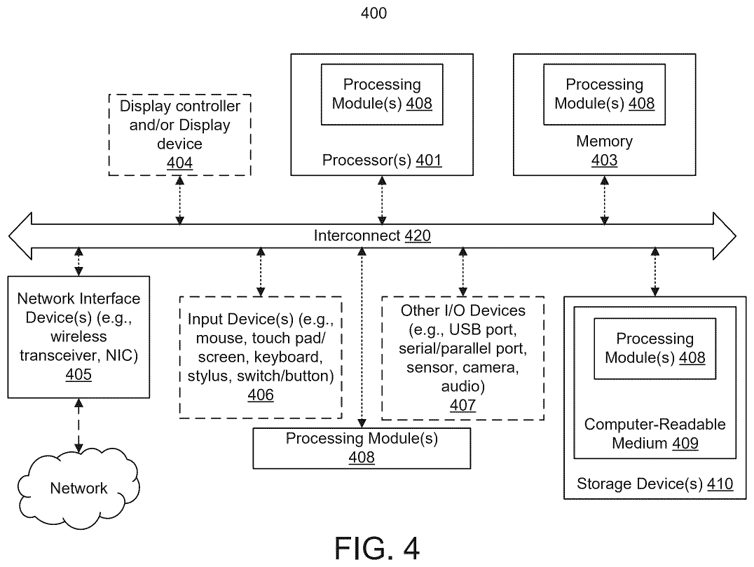

Any of manufacturer system 100, endpoint devices 102, voucher management system 110, rendezvous system 120, deployment 130, orchestrator 132, endpoint devices 134, and compliance policy manager 139 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with communication system 140. Communication system 140 may facilitate communications between the components of FIG. 1A. In an embodiment, communication system 140 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

As discussed above, endpoint devices (e.g., 102) may traverse through a stream of commerce between when the endpoint devices are manufactured and when the endpoint devices reaches a final owner. Turning to FIG. 1B, diagram of an example path through a stream of commerce in accordance with an embodiment is shown.

In FIG. 1B, vertical dashed lines indicate different geographic locations in which various facilities may be positioned. Representations of such facilities (e.g., 150-154) may be positioned below the pages. Representations of movement of endpoint devices between these facilities is illustrated using truck shaped images. Some instances of the graphical representation of endpoint device 103 are illustrated using dashed outlining to indicate that endpoint device 103 may only be present at one of the facilities at any point in time, and the instance of the graphical representation of endpoint device 103 drawn in solid outlining indicates where endpoint device 103 is located in the example shown in FIG. 1B.

The stream of commerce may begin, for example, at manufacturer facility 150. Manufacturer facility 150 may be a facility operated by a manufacturer of endpoint devices. During manufacturing, the manufacturer may establish a root of trust for an endpoint device (e.g., 103), install various software, add hardware components, etc. Refer to FIG. 1C for additional details regarding establishing the root of trust for endpoint device 103. The root of trust may be used by endpoint device 103 to discern which entities have authority over it, which entities to trust, and/or for other purposes. The initial root of trust may indicate that the manufacturer is the owner of and has authority over endpoint device 103.

Once the root of trust is established, endpoint device 103 may be sold and resold to various intermediate owners. These intermediate owners may operate various intermediate owner facilities (e.g., 152), such as warehouses, distribution centers, sales rooms, etc. When sold, endpoint device 103 may be shipped to these various facilities. While at these facilities, various software and/or hardware component modifications may be made. Accordingly, the state of endpoint devices 103 may change.

Finally, once purchased from an intermediate owner, a final owner may operate a final owner facility (e.g., 154), such as a data center, edge deployment, and/or other type of computer deployment to which endpoint device 103 may be onboarded. To facilitate onboarding, voucher management system 110 may collect and add information regarding changes in ownership of endpoint device 103 to an ownership voucher. Orchestrator 132 may use the ownership voucher to establish authority over endpoint device 103. Refer to FIG. 1J-1K for additional details regarding establishing authority over endpoint devices during onboarding.

Turning to FIG. 1C, a diagram of an example process for establishing a root of trust in endpoint device 103 in accordance with an embodiment is shown. To establish a root of trust, when endpoint device 103 is manufactured, root of trust 160 may be installed in endpoint device 103.

Root of trust 160 may be a public key of a public private key pair controlled by the manufacturer of endpoint device 103. The public private key pair may be established using any process.

To install root of trust 160, root of trust 160 may be stored in endpoint device 103. The storage location and security precautions taken with respect to storing root of trust 160 may vary depending on the architecture of endpoint device 103.

For example, endpoint device 103 may host or include a security manager (e.g., 162). Security manager 162 may be implemented using a discrete hardware component, or may be a software component. Security manager 162 may enforce various security policies on endpoint device 103. For example, the security policies may require that endpoint device 103 validate authority over it back to root of trust 160 before complying with any instructions from other entities that allege to have authority over endpoint device 103.

To validate entities having authority over endpoint device 103, endpoint device 103 may utilize ownership vouchers.

Turning to FIG. 1D, a diagram of an example process for generating ownership voucher 176 in accordance with an embodiment is shown. To generate ownership voucher 176, information regarding changes in ownership and authority over an endpoint device may be added. The information may take the form of a cryptographically verifiable certificate (e.g., 178). Refer to FIG. 1E for additional information regarding certificate 178.

To add a certificate to ownership voucher 176, transfer process 174 may be performed. During transfer process 174, ownership transfer data 170 and private key 172 may be obtained. Ownership transfer data 170 may document a change in ownership and/or authority over an endpoint device. For example, when an endpoint device is sold, a public key of a public private key pair controlled by the purchaser may be added to ownership transfer data 170, along with other types of information regarding the transfer. This public key may be usable to verify signed work orders or other signed data structures from the new owner (e.g., the new owner may be able to use the corresponding private key for signing). The information in ownership transfer data 170 may be treated as a delegation statement, which an endpoint device may parse to identify entities having authority over it.

Private key 172 may be a private key of a public private key pair controlled by an entity that has authority over an endpoint device at the time authority over the endpoint device changes (e.g., via sale or other mechanism). In a scenario in which the manufacturer is the seller, the private key corresponding to the root of trust may be private key 172. Similarly, in a scenario in which an intermediate owner is the seller, private key 172 may be the private corresponding to the public key included in the delegation statement in ownership voucher 176 that establishes the intermediate owner has the owner of the endpoint device. In other words, to establish a delegation of authority, the entity that has authority over the endpoint device as defined by the certificates of ownership voucher 176 may need to sign the ownership transfer data 170 to further delegate ownership and authority over the endpoint device. By doing so, a chain of delegations that are cryptographically verifiable back to the root of trust may be established. Refer to FIGS. 1F-1H for additional details regarding establishing chains of delegations.

Any number of certificates may be added to ownership voucher 176 thereby enabling certificate chains that establish chains of delegation from the root of trust for an endpoint device. Ownership voucher 176 may, as discussed above, be used during onboarding.

Turning to FIG. 1E, a diagram of an example certificate 178 in accordance with an embodiment is shown. Certificate 178 may include delegation 179A and cryptographic data 179B.

Delegation 179A may include information documenting a delegation of authority/ownership over an endpoint device. For example, delegation 179A may include a public key, and indicate what is delegated to the entity that has control over the public private key pair of which the public key is a member. The extent of what is delegated may be specified at a macro level (e.g., ownership) or a micro level (e.g., limited authority).

Cryptographic data 179B may include signature usable to verify the integrity of delegation 179A and ascertain whether delegation 179A is valid.

To determine whether certificate 178 includes a valid delegation, an endpoint device may attempt to establish a chain of delegations back to the root of trust.

Turning to FIG. 1F, a diagram of an example certificate chain 182 of ownership voucher 176 in accordance with an embodiment is shown. Certificate chain 182 may be a series of certificates that can be sequentially validated back to the root of trust. To sequentially validate the certificate back to the root of trust, the first certificate (e.g., 178) in the chain may attempt to be validated using the root of trust (e.g., a public key). Thus, the first certificate in the chain may only be validated if the private key (e.g., controlled by the manufacturer) corresponding to the root of trust was used to sign certificate 178. Other certificates in the chain may be similarly validated by using the public key from the delegation statement of the previous certificate to check the signature in the next certificate in the chain. Certificate chain 182 may include any number of certificates (e.g., 178-180) that can be sequentially verified back to the root of trust. Refer to FIGS. 1G-1H for additional information regarding establishing valid certificate chains.

Turning to FIG. 1G, a diagram of an example process for validating a portion of a certificate chain of an ownership voucher in accordance with an embodiment is shown. In FIG. 1G, two certificates (e.g., 184, 188) from a certificate chain are shown.

As seen, certificate 184 may include delegation 185 which includes a public key (e.g., 186) of a second entity. The delegation statement may indicate that a first entity is delegating authority to the second entity.

Certificate 184 may include signature 187. Signature 187 may be generated using a private key controlled by the first entity that delegated authority to the second entity. In this example, the private key may correspond to root of trust 160 (e.g., may be a private corresponding to the public key installed when an endpoint device is manufactured).

To establish a certificate chain, signature 187 may be checked using root of trust 160. If verified as having been signed using the private key corresponding to the root of trust, then certificate 184 may be treated as being valid.

Like certificate 184, certificate 188 may include delegation 189 which includes a public key (e.g., 190) of a third entity, and in this example the owner. The delegation statement of delegation 189 may indicate that the second entity is delegating authority to the third entity (i.e., the owner).

Certificate 188 may include signature 191. Signature 91 may be generated using a private key controlled by the second entity that delegated authority to the third entity. In this example, the private key may correspond to the public key (e.g., 186) of the second entity which may be included in delegation 185.

To extend the certificate chain, signature 191 may be checked using public key of second entity 186. If verified as having been signed using the private key corresponding to public key of second entity 186, then certificate 188 may be treated as being valid.

Once the chain is established, the delegations (e.g., 185, 189) in the chain may be parsed to identify keys to which authority has been delegated from root of trust 160. These public key may then be used to decide whether various work orders are valid, which entities have authority of an endpoint device, and/or for other purposes.

For example, during onboarding, an endpoint device may evaluate whether to perform various work orders using the keys to which authority has been delegated.

Turning to FIG. 1H, a diagram of an example process for validating a work order in accordance with an embodiment is shown. In FIG. 1H, only a portion of the certificates (e.g., 184, 188) shown in FIG. 1G are shown for clarity.

When a work order (e.g., 196) is received by an endpoint device, the endpoint device may evaluate whether the entity issuing the work order has authority over the endpoint device. To do so, the endpoint device may parse the certificates to identify the public keys to which authority over the endpoint device has been delegated.

The endpoint device may then, using the keys, check a signature (e.g., 198) included in the work order. If the signature can be verified as having been generated using the private key corresponding to one of the public keys to which authority over the endpoint device has been delegated, then the endpoint device may treat work order 196 as having been issued by an entity with authority over it. For example, signature 198 may be checked using public key of owner entity 190, in this example.

The endpoint device may then, for example, process various statements 197 included in work order 196, and take action based on those statements. These statements may include instructions that change the manner of operation of the endpoint device to, for example, comply with security requirements of a new owner, and/or perform other actions.

However, even if validated, performance of the workorder by an endpoint device may present risk. For example, if the endpoint device is compromised (e.g., due to not meeting security expectations of an operator of a deployment), then the workload performed by the endpoint device may also be compromised. A malicious entity may use the endpoint device to modify the process performed during the workload, to copy information generated when the work order is performed, and/or other undesired outcomes may occur.

For example, turning to FIG. 1I which shows a diagram in accordance with an embodiment, signed data 204 such as a work order may be validated if public keys included in ownership voucher certificate chains (e.g., 202) correspond to private keys to which the work order issuing entity has access. In this example, ownership voucher certificate chain 202 may be used to establish delegations of authority from root of trust 200 for an endpoint device to the keys used to sign signed data 204.

However, this verification process may not include security verification for the endpoint device itself. Thus, the endpoint device may serve as an attack vector for workloads performed by the endpoint device, other endpoint devices of a deployment, and/or other entities.

To reduce the likelihood of such compromises from impacting the services provided by a deployment, the orchestrator of a deployment may proactively, reactively, and/or preventatively check the states of endpoint devices to ensure that they meet criteria for an organization. FIGS. 1J-1K show examples of data structures that may be used in such processes.

Turning to FIG. 1J, a diagram illustrating an example compliance policy 220 in accordance with an embodiment is shown. Compliance policy 220 may be a policy usable to discriminate endpoint devices that meet expectations of an operator of a deployment from endpoint devices that do not meet the criteria.

Compliance policy 220 may be established by an operator of a deployment, or another entity and the operator of the deployment may adopt the compliance policy. For example, various compliance policies may be enrolled to an orchestrator of a deployment.

Each compliance policy may have a different scope of applicability (e.g., may only apply to certain types of devices, devices that are to perform certain roles, etc.), and may include metrics 222, requirements 224, and signatures 226.

Metrics 222 may indicate criteria by which an endpoint devices is judged as either being acceptable (e.g., meets operator expectations with respect to, for example, security) or unacceptable. Metrics 222 may include (i) manufacturers, (ii) types of devices, (iii) components of devices (e.g., software and/or hardware), (iv) configuration for the software and/or hardware components, etc. Metrics 222 may require that an endpoint device or orchestrator establish possession of cryptographically verifiable data structures (e.g., back to the root of trust for the device) establishing the aforementioned information is met by an endpoint device.

For example, a manufacturer, intermediary, a certificate granting authority, or other source may generate certificate signed with a key that is verifiable back to the root of trust. The certificate may specify any of the above information (e.g., that an endpoint device was manufactured by a particular manufacturer, that that the endpoint device is a type of device such as a storage server, that the endpoint device include a security process such as a trust platform module and/or that the endpoint device hosts malware scanning software, etc.). The aforementioned information may serve as an attestation as to a quality of the device.

In an embodiment, the certificate (or content thereof) is included in an ownership voucher or a secure component validation certificate. Thus, such certificates may be validated back to the root of trust for the endpoint device, orchestrator, etc.

Requirements 224 may indicate additional criteria by which an endpoint devices is judged as either being acceptable (e.g., meets operator expectations with respect to, for example, security) or unacceptable. In contrast to metrics 222 which are satisfied with attestations, requirements 224 indicate certain measurements or information that is to be collected from and compared to standards.

The information to be collected from the endpoint device may include, for example, security posture information provided by a trusted platform module, hardware attestations from hardware components of the endpoint device (e.g., attesting to security postures of the individual hardware components), presence of certain cryptographic information such as particular keys, type of hardware components and capabilities, types of firmware and corresponding vendors, types of boot loaders or other types of startup management entities, host management systems such as operating systems, security practices and/or capabilities (e.g., presence of specific types of trusted platform modules), system configurations such as (i) secure boot and/or other startup security processes, (ii) limits on boot device options, (iii) limits on startup process selection, and/or other types of restrictions on operation of the endpoint device.

Signature 226 may be a signature usable to validate integrity of and trust in compliance policy 220. For example, compliance policy 220 may be signed by a trusted entity, and the orchestrator may have access to corresponding keys usable to verify such signatures.

If all of metrics 222 and requirements 224 can be met by an endpoint device, then the endpoint device may be judged as being secure for the operator of the deployment. It will be appreciated that any number of compliance policies may apply to any endpoint device.

However, in some cases, operators of deployments may wish to allow for some deviation and/or grading the posture of endpoint devices. In such scenarios, the operators may establish or adopt scoring systems. The scoring systems may be used, for example, to quantify a level of compliance with a compliance policy.

Turning to FIG. 1K, a diagram illustrating an example scoring system 230 in accordance with an embodiment is shown. Scoring system 230 may include information usable to grade and determine based on the grades whether an endpoint device should be judged as secure. Scoring system 230 may include associations 232, points 234, and criteria 236.

Associations 232 may associate different metrics and/or requirements of a compliance policy with corresponding point values specified by points 234. Each metric and/or requirement of a security policy may have a corresponding point value. If the corresponding metric/requirement is met, then scoring system 230 may ascribe the associated number of points to the endpoint device.

Points 234, as noted above, may provide for converting compliance with metrics/requirements of a compliance policy into a numerical value. The numerical value may be static based on whether the corresponding metric/requirement is met, or may be proportional based on the level of compliance of an endpoint device with the corresponding metric/requirement.

For example, a requirement of requirements 224 may specify that an endpoint device is to have at least two security processors, with a maximum point value of two. However, if the endpoint device only has one security processor, then a point value of zero (e.g., if the points of scoring system 230 does not provide for proportional scoring) or one (e.g., if the points of scoring system 230 does provide for proportional scoring) may be assigned. While described with a direct proportionality example, it will be appreciated that the number of points that may be awarded for compliance each metric/requirement may use a more complicated relationship.

Criteria 236 may include one or more tests to ascertain whether the points ascribed by scoring system 230 to an endpoint device indicate that the endpoint device is secure. The criteria maybe, for example, a threshold based on an aggregate number of points, thresholds for different metrics/requirements that are scored, etc.

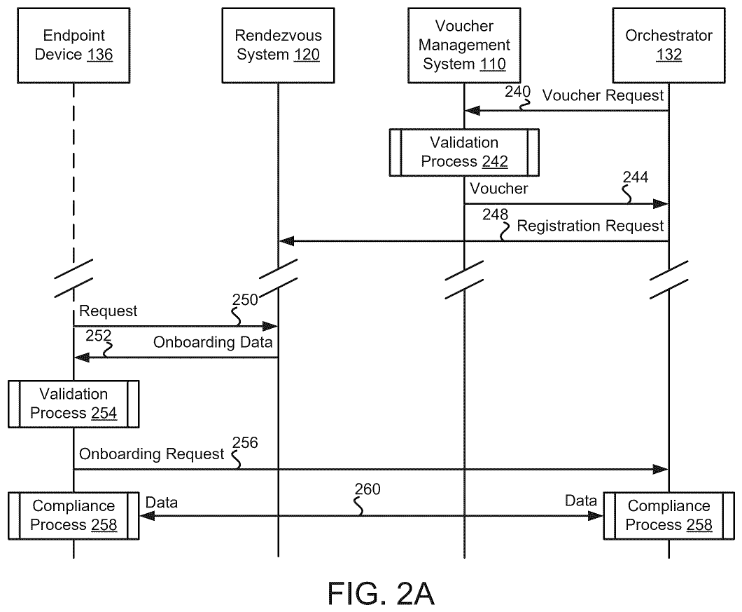

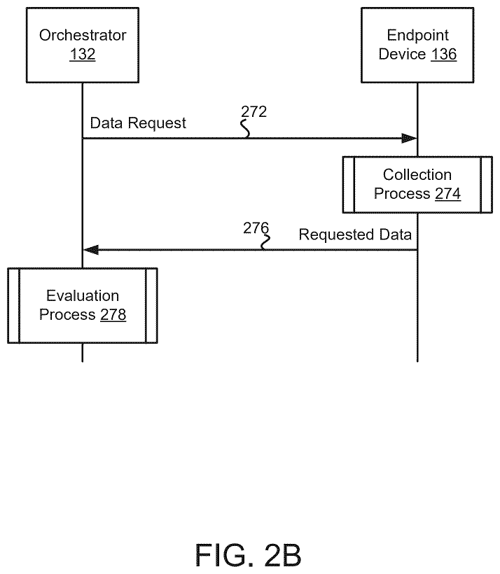

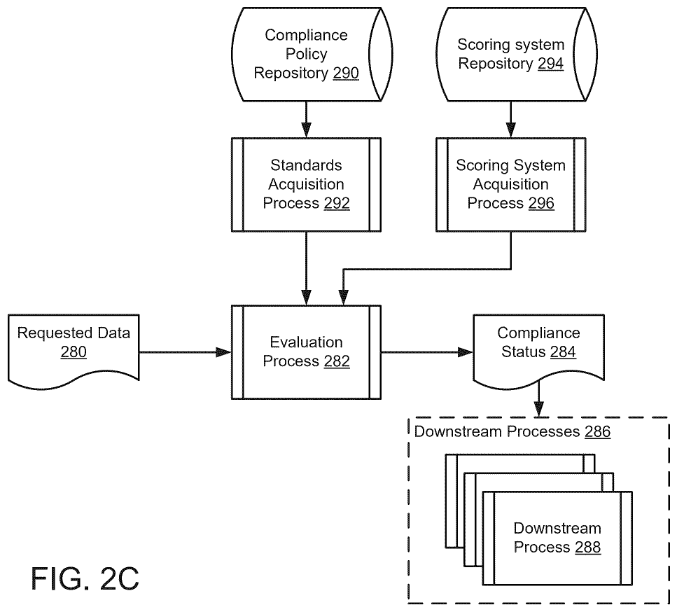

To further clarify embodiments disclosed herein, interactions diagrams in accordance with an embodiment are shown in FIGS. 2A-2B. These interactions diagrams may illustrate how data may be obtained and used within the system of FIGS. 1A-1K.

In the interaction diagrams, processes performed by and interactions between components of a system in accordance with an embodiment are shown. In the diagrams, components of the system are illustrated using a first set of shapes (e.g., 110, 120, 132, 136, etc.), located towards the top of each figure. Lines descend from these shapes. Some descending lines are drawn in dashing to indicate that the device is not operating during corresponding periods of time, while other lines are drawn solid to indicate that the devices are operating during the corresponding period of time. For example, in FIG. 2A, endpoint device 136 may not be operating until interaction 250.

Processes performed by the components of the system are illustrated using a second set of shapes (e.g., 242, 254, etc.) superimposed over these lines. Interactions (e.g., communication, data transmissions, etc.) between the components of the system are illustrated using a third set of shapes (e.g., 240, 244, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 240 may occur prior to the interaction labeled as 244. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during onboarding of an endpoint device.

To onboard endpoint device 136, orchestrator 132 may, at interaction 240, send a voucher request to voucher management system 110. The voucher request may be a request for an ownership voucher for an endpoint device (e.g., 136). In the example interactions shown in FIG. 2A, an entity may have purchased endpoint device 136 thereby causing voucher management system 110 to add information to the ownership voucher for endpoint device 136 that establishes chains of certificates/delegations from the root of trust to the owner.

When received, voucher management system 110 may attempt to validate the voucher request by performing validation process 242. During validation process, credentials and/or other information from orchestrator 132 may be evaluated to ascertain whether an ownership voucher should be provided. Presuming that the validation process is successful, at interaction 244, voucher management system 110 may send an ownership voucher to orchestrator 132.

Once obtained, at interaction 248, orchestrator 132 may send a registration request to rendezvous system 120. The registration request may be a request to have rendezvous system 120 redirect endpoint device 136 to orchestrator 132. The registration request may include information usable by rendezvous system 120 to verify that orchestrator 132 should have authority over endpoint device 136 (e.g., may be portions of the ownership voucher, or entire ownership voucher).

Once endpoint device 136 reaches a destination location (e.g., a data center, edge deployment, etc.), endpoint device 136 may be powered on may, at interaction 250, send a request to rendezvous system 120 regarding which entity to contact as part of an onboarding procedure.

Presuming the rendezvous system 120 registered orchestrator 132 based on the registration request, rendezvous system may, at interaction 252, provide onboarding data to endpoint device 136. The onboarding data may include, for example, various validation information and re-direct information (e.g., network address) for orchestrator 132.

Once obtained, endpoint device 136 may perform validation process 254. During validation process 254, endpoint device 136 may attempt to validate the onboarding data. If successfully validated, endpoint device 136 may, at interaction 256, generate and send an onboarding request to orchestrator 132. The onboarding request may request, for example, cryptographic data such as ownership vouchers.

Send of the onboarding request may initiate compliance process 258. During compliance process, orchestrator 132 may (i) identify compliance policies that apply to endpoint device 136, (ii) attempt to collect information (e.g., data send at interaction 260 between the devices), and (iii) use the data to determine whether endpoint device 136 satisfies the compliance policy.

If endpoint device 136 satisfies the compliance policy, then an onboarding process may be performed. During the onboarding process, orchestrator 132 may provide endpoint device 136 with the ownership voucher and/or other information to enable endpoint device 136 to ascertain whether orchestrator 132 has authority over endpoint device 136. To do so, endpoint device 136 may, as discussed above, attempt to validate certificate chains and delegation statements to establish a chain of delegation of authority from the root of trust to orchestrator 132 (e.g., the delegation statements may identify a particular public key for which orchestrator 132 controls a corresponding private key). Endpoint device 136 may issue various challenges (e.g., signing challenges) to orchestrator 132, and endpoint device 136 may test the signed responses to the challenges using the particular public key. If the signed responses can be validated using the public key, then endpoint device 136 may conclude that orchestrator 132 has authority over it.

If successfully validated as having authority over it, endpoint device 136 may continue to participate in the onboarding by, for example, evaluating the trustworthiness of signed work orders issued by orchestrator 132, and complying with any signed work orders that can be validated as having been signed with the private key corresponding to the particular public key.

The aforementioned work orders may cause endpoint device 136 to, for example, modify its configuration, install/remove software, enable/disable various hardware components, establish accounts for end users, and/or perform other operations as directed by orchestrator 132. The aforementioned operations may place endpoint device 136 in an operating state specified by the owner of endpoint device 136.

Similar compliance processes may be performed (e.g., prior to) when work orders are assigned, and/or at other points in time for auditing purposes.

To evaluate whether an endpoint device meets a compliance policy, information may be collected from the endpoint device.

Turning to FIG. 2B, a second interaction diagram in accordance with an embodiment is shown. The second interaction diagram may illustrate processes and interactions that may occur during information collection from an endpoint device to evaluate a compliance state of the endpoint device.

To obtain information usable to identify whether endpoint device 136 meets requirements of compliance policies, orchestrator 132 may, at interaction 272, send a data request to endpoint device 136. The data request may be for any type and quantity of information based on a compliance policy that applied to endpoint device 136.

Based on the data request, endpoint device 136 may perform collection process 274. During collection process, endpoint device 136 attempt to collect the requested data. For data that is unable to be collected, endpoint device 136 may record a null or other type of entry that indicates that the data was not collected.

Once collection process 274 is complete, endpoint device 136 may, at interaction 276, send the requested data to orchestrator 132. Once obtained, orchestrator 132 may perform evaluation process 278. During evaluation process 278, orchestrator 132 may ascertain a compliance state of endpoint device 136 with respect to one or more compliance policies. For those compliance policies for which for scoring systems are applicable, numerical scores may be calculated and used as a basis for making the state determinations.

The result of evaluation process 278 may be that the endpoint devices is judged as having or not having a compliant state with respect to any number of compliance policies. These states may be used in subsequent processing, discussed further with respect to FIG. 2C.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, a data flow diagram in accordance with an embodiment is shown in FIG. 2C. In the diagram, flows of data and processing of data are illustrated using different sets of shapes. A first set of shapes (e.g., 280, 284, etc.) is used to represent data structures, a second set of shapes (e.g., 292, 282, etc.) is used to represent processes performed using and/or that generate data, and a third set of shapes (e.g., 290, 294, etc.) is used to represent large scale data structures such as databases.

Turning to FIG. 2C, a first data flow diagram in accordance with an embodiment is shown. The first data flow diagram may illustrate data used in and data processing performed in managing endpoint devices based on their compliance states.

To manage the endpoint devices, requested data 280 may be obtained. The requested data may be similar to that discussed with respect to FIG. 2B.

Once obtained, the requested data may be ingested by evaluation process 282. During evaluation process 282, requested data 280 and/or other data (e.g., attestations which may be obtained from the endpoint device or other sources) may be evaluated with respect to one or more compliance policies stored in compliance policy repository 290.

For example, for a given endpoint device, standards acquisition process 292 may be performed to identify applicable compliance policies from compliance policy repository 290. The compliance policies may be applicable to different situations, and information regarding the endpoint device may be used to discriminate applicable from inapplicable policies.

The applicable compliance policies may be used in evaluation process 282 to identify whether the endpoint device complies with each policy (e.g., by comparison). Each of the policies from compliance policy repository 290 may have been previously enrolled with the orchestrator for evaluation. For example, an administrator or other entity may instruct the orchestrator to use the compliance policies in various tasks (e.g., onboarding, workload assignment, etc.).

In the event that an operator of a deployment has adopted scoring systems, scoring system acquisition process 296 may be performed. Like standards acquisition process, during scoring system acquisition process 296, scoring systems from scoring system repository 294 may be discriminated against with respect to the compliance policies that were identified as relevant. In other words, the scoring systems may be keyed to corresponding compliance policies and scoring system acquisition process 296 may use those associations to identify applicable scoring policies for the identified compliance policies.

Once obtained, the applicable scoring policies may also be used in identifying the compliance statuses (e.g., 284) of the endpoint device with respect to each compliance policy.

Each of the scoring systems from scoring system repository 294 may have been previously enrolled with the orchestrator for evaluation. For example, an administrator or other entity may instruct the orchestrator to use the scoring systems in various tasks (e.g., onboarding, workload assignment, etc.).

Once compliance status 284 is obtained, compliance status 284 may be used in various downstream processes 286. The downstream processes 286 may include, for example, onboarding processes, workload assignment processes, auditing processes, and/or other processes performed with respect to the endpoint device. The downstream processes may use compliance status 284 to, for example, decide whether to continue with onboarding, to assign workloads to the endpoint device, establish audit trails for the endpoint device, and/or for other purposes.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, the flow, processes, and interactions shown in FIGS. 2A-2C may be used to facilitate endpoint device management using evaluations of the endpoint devices that are customized to the operator of the endpoint devices. Accordingly, the security of each endpoint device may, for example, be evaluated in accordance with a standard that is relevant to the deployment operator.

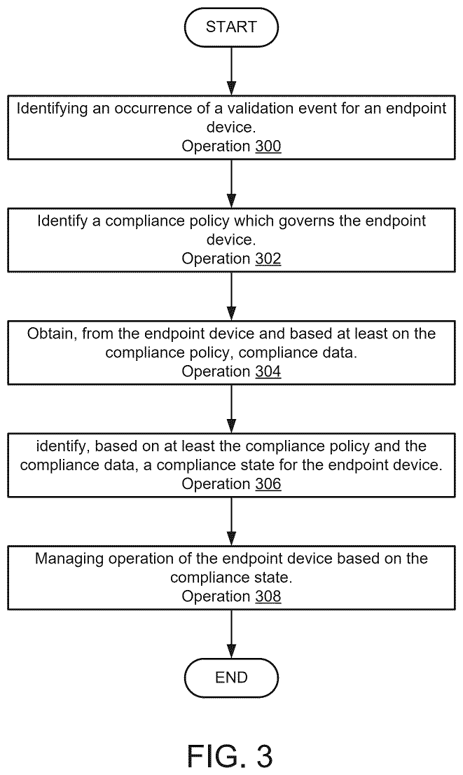

As discussed above, the components of FIG. 1A may perform various methods to onboarding endpoint devices. FIG. 3 illustrates a method that may be performed by the components of the system of FIGS. 1A-1K. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of endpoint devices in accordance with an embodiment is shown. The method may be performed by any of the components of the system shown in FIG. 1A.

At operation 300, an occurrence of a validation event for an endpoint device is identified. The validation event may be identified by matching occurrences of events against particular types of events (e.g., onboarding, workload assignment, auditing, etc.).

At operation 302, a compliance policy which governs the endpoint device is identified. The compliance policy may be identified by (i) obtaining information regarding the endpoint devices, and (ii) using the information to discriminate applicable from inapplicable compliance policies. The information may be any type of information regarding the endpoint device.

At operation 304, compliance data is obtained from the endpoint device. The compliance data may be based on the compliance policy. The compliance data may be obtained by requesting the compliance data from the endpoint device (e.g., as discussed with respect to FIGS. 2A-2B).

At operation 306, a compliance state for the endpoint device is identified based on the compliance data and the compliance policy. The compliance state may also be identified based on a scoring system, if any are applicable. The compliance state may be identified by evaluating the compliance policy in view of the compliance data, attestations, and/or other information regarding the endpoint device. The compliance state may be in or out of compliance, depending on the evaluation.

In the event that an applicable scoring system is available, the scoring system may be used to compute one or more values. These values may be compared to criteria (e.g., thresholds) to ascertain whether the endpoint device is in or out of compliance with the compliance policy.

At operation 308, the operation of the endpoint device is managed based on the compliance state. The operation of the endpoint device may be managed by guiding subsequent actions based on the compliance state. For example, if an onboarding is being performed, the onboarding may be aborted or modified if the endpoint device is out of compliance. Similarly, if a workload assignment is being performed, the endpoint device may not be selected as a candidate for the workload if the endpoint device is out of compliance. The method may end following operation 308.

Thus, using the method shown in FIG. 3, embodiments disclosed herein may reduce the likelihood of endpoint devices serving as vectors of attack by facilitate compliance analysis that is relevant to an operator of a deployment.

Any of the components illustrated in FIGS. 1A-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 420. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 420 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 410 may include computer-readable storage medium 409 (also known as a machine-readable storage medium or a computer-readable medium) on which is stored one or more sets of instructions or software (e.g., processing module, unit, and/or processing module/unit/logic 408) embodying any one or more of the methodologies or functions described herein. Processing module/unit/logic 408 may represent any of the components described above. Processing module/unit/logic 408 may also reside, completely or at least partially, within memory 403 and/or within processor 401 during execution thereof by system 400, memory 403 and processor 401 also constituting machine-accessible storage media. Processing module/unit/logic 408 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 408, components and other features described herein can be implemented as discrete hardware components or integrated in the functionality of hardware components such as ASICS, FPGAs, DSPs or similar devices. In addition, processing module/unit/logic 408 can be implemented as firmware or functional circuitry within hardware devices. Further, processing module/unit/logic 408 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing endpoint devices, the method comprising:
identifying an occurrence of a validation event for an endpoint device of the endpoint devices;
based on the occurrence of the validation event:
identifying a compliance policy which governs the endpoint device;
obtaining, from the endpoint device and based at least on the compliance policy, compliance data;
identifying, based on at least the compliance policy and the compliance data, a compliance state for the endpoint device; and
managing operation of the endpoint device based on the compliance state.

2. The method of claim 1, wherein the compliance policy is specified by an operator a deployment which the endpoint device is attempting to join.

3. The method of claim 2, wherein the validation event is an attempted onboarding of the endpoint device to the deployment.

4. The method of claim 3, wherein managing operation of the endpoint device based on the compliance state comprises:
in a first instance of the identifying where the compliance state is non-compliant:
preventing the onboarding of the endpoint device to complete prior to remediation of the compliance state; and
in a second instance of the identifying where the compliance state is compliant:
allowing the onboarding of the endpoint device to be completed without the remediation of the compliance state.

5. The method of claim 4, further comprising:
providing computer implemented services using the endpoint device after onboarding to the deployment is completed.

6. The method of claim 1, wherein the compliance policy specifies metrics which must be met for the compliance state of the endpoint device to be identified as compliant.

7. The method of claim 6, wherein the metrics comprise at least one metric selected from a list of metrics consisting of:
possession of a first certificate indicating that the endpoint device was manufactured by a predetermined entity and signed by the predetermined entity;
possession of a second certificate indicating that the endpoint device was manufactured by a predetermined entity and signed by an intermediate entity which the predetermined entity has delegated authority over the endpoint device;
possession of a third certificate indicating that the endpoint device is a particular type of device; and
possession of a fourth certificate indicating that the endpoint device comprises a particular type of hardware.

8. The method of claim 7, wherein at least one of the first certificate, the second certificate, the third certificate, and the fourth certificate is part of an onboarding voucher that delegates authority of the endpoint device to an operator of the endpoint device.

9. The method of claim 6, wherein the compliance policy further specifies characteristics of the endpoint device which must be met for the compliance state of the endpoint device to be identified as compliant.

10. The method of claim 9, wherein the characteristics comprise at least one characteristic selected from a list of characteristics consisting of:
a type of hardware component in an inventory of the endpoint device;
a type of firmware hosted by the endpoint device;
a type of boot loader hosted by the endpoint device;
a type of operating system hosted by the endpoint device; and
a security architecture implemented by the endpoint device.

11. The method of claim 1, further comprising:
obtaining a scoring system; and
obtaining a quantification based, at least in part, on the compliance policy,
wherein the compliance state is identified by comparing the quantification to a criteria specified by the scoring system.

12. The method of claim 1, wherein the validation event is an assignment of a workload.

13. The method of claim 12, wherein managing the operation of the endpoint device comprises:
in a first instance of the identifying where the compliance state is non-compliant:
rejecting the endpoint device as a candidate for the workload; and
in a second instance of the identifying where the compliance state is compliant:
accepting the endpoint device as the candidate for the workload.

14. The method of claim 1, wherein the validation event is an audit of the endpoint device.

15. A non-transitory machine-readable medium having instructions stored therein, which when executed by a processor, cause the processor to perform operations for managing endpoint devices, the operations comprising:
identifying an occurrence of a validation event for an endpoint device of the endpoint devices;
based on the occurrence of the validation event:
identifying a compliance policy which governs the endpoint device;
obtaining, from the endpoint device and based at least on the compliance policy, compliance data;
identifying, based on at least the compliance policy and the compliance data, a compliance state for the endpoint device; and
managing operation of the endpoint device based on the compliance state.

16. The non-transitory machine-readable medium of claim 15, wherein the compliance policy is specified by an operator a deployment which the endpoint device is attempting to join.

17. The non-transitory machine-readable medium of claim 16, wherein the validation event is an attempted onboarding of the endpoint device to the deployment.

18. A management system, comprising:
a processor; and
a memory coupled to the processor to store instructions, which when executed by the processor, cause the management system to perform operations for managing an endpoint device, the operations comprising:
identifying an occurrence of a validation event for an endpoint device of the endpoint devices;
based on the occurrence of the validation event:
identifying a compliance policy which governs the endpoint device;
obtaining, from the endpoint device and based at least on the compliance policy, compliance data;
identifying, based on at least the compliance policy and the compliance data, a compliance state for the endpoint device; and
managing operation of the endpoint device based on the compliance state.

19. The endpoint device of claim 18, wherein the compliance policy is specified by an operator a deployment which the endpoint device is attempting to join.

20. The endpoint device of claim 19, wherein the validation event is an attempted onboarding of the endpoint device to the deployment.
